(19) United States
(12) Patent Application Publication
(10) Pub. No.: US 2024/0308317 A1
(43) Pub. Date: Sep. 19, 2024

(54) VEHICLE WINDSHIELD COVER WITH AN EXTENSION FLAP

(71) Applicant: Delk Industries, Inc., Portland, TN (US)

(72) Inventors: Yueqi Wang, Nashville, TN (US); Raymond Don Barnes, JR., Nashville, TN (US); Cory Thomas Jackson, Nashville, TN (US)

(73) Assignee: Delk Industries, Inc, Portland, TN (US)

(21) Appl. No.: 18/183,826

(22) Filed: Mar. 14, 2023

Related U.S. Application Data
(63) Continuation-in-part of application No. 18/183,749, filed on Mar. 14, 2023.

(51) Int. Cl. B60J 11/08

(52) U.S. Cl. CPC B60J 11/08

(57) ABSTRACT

A vehicle windshield cover, comprising: a main cover portion and extension flaps. The Extension flaps may be attached to said main cover portion and may have an extended position and a folded position. When the extension flaps are in said extended position, the vehicle windshield cover is configured to cover a windshield that is larger than that which can be covered by the vehicle windshield cover when said extension flaps are in said folded position.

### CROSS-REFERENCE TO RELATED APPLICATIONS

The application is a continuation-in-part of U.S. Non-Provisional patent application Ser. No. 18/183,749, filed on Mar. 14, 2023, titled “VEHICLE WINDSHIELD PROTECTION SECURITY STRAP AND SUCTION CUP DEVICE”, the contents of which are expressly incorporated herein by this reference, and to which priority is claimed.

### FIELD OF THE DISCLOSURE

The present disclosure generally relates to windshield glass covering devices or windshield covers. More particularly, the present disclosure generally relates to a windshield cover that has one or more extension flaps that allows the cover to be used on a range of windshield sizes.

### SUMMARY

To minimize the limitations in the prior art, and to minimize other limitations that will become apparent upon reading and understanding the present specification, the present disclosure discloses a new and useful vehicle windshield protection device or cover with extension flaps.

One embodiment may be a vehicle windshield cover, comprising: a main cover portion; and one or more extension flaps; wherein the one or more extension flaps are attached to the main cover portion; wherein the one or more extension flaps have an extended position and a folded position; and wherein when the one or more extension flaps are in the extended position, the vehicle windshield cover is configured to cover a windshield that is larger than that which can be covered by the vehicle windshield cover when the one or more extension flaps are in the folded position. The vehicle windshield cover may further comprise one or more security straps and/or one or more side straps. The one or more extension flaps may be two extension flaps. The two extension flaps may be attached to two opposing sides of the main cover portion. The two extension flaps may be permanently attached to a bottom surface of the main cover portion, such that when the two extension flaps are in the folded position they may be substantially held flat against the bottom surface of the main cover portion when the vehicle windshield cover is engaged with a vehicle windshield. The two extension flaps may be removably attached to the main cover portion. The two extension flaps may be approximately the same length as the two opposing sides of the main cover portion. The extension flaps may be weighted. The extension flaps may have a Polyvinyl Chloride coating, such that the one or more extension flaps remain flexible in temperatures below 0° C.

Another embodiment may be an extension flap for a vehicle windshield cover, comprising: a first extension flap; wherein the first extension flap is configured to attach to a main cover portion of a vehicle windshield cover; wherein the first extension flap has an extended position and a folded position; wherein when the first extension flap is in the extended position, the vehicle windshield cover is configured to cover a windshield that is larger than that which can be covered by the vehicle windshield cover when the first extension flap is in the folded position. The extension flap may further comprise a second extension flap, such that there are two extension flaps. The two extension flaps may be attached to two opposing sides of the main cover portion. The two extension flaps may be permanently attached to a bottom surface of the main cover portion, such that when the two extension flaps are in the folded position they are substantially held flat against the bottom surface of the main cover portion when the vehicle windshield cover is engaged with a vehicle windshield. The two extension flaps may be removably attached to the main cover portion. The two extension flaps may be approximately the same length as the two opposing sides of the main cover portion. The first extension flap may have a Polyvinyl Chloride coating, such that the first extension flap remains flexible in temperatures below 0° C.

Another embodiment may be a vehicle windshield cover, comprising: a main cover portion; one or more security straps; and two extension flaps; wherein the two extension flaps are attached to two opposing sides of the main cover portion; wherein the two extension flaps have an extended position and a folded position; wherein when the two extension flaps are in the extended position, the vehicle windshield cover is configured to cover a windshield that is larger than that which can be covered by the vehicle windshield cover when the two extension flaps are in the folded position. The two extension flaps may be permanently attached to a bottom surface of the main cover portion, such that when the two extension flaps are in the folded position they are substantially held flat against the bottom surface of the main cover portion when the vehicle windshield cover is engaged with a vehicle windshield. The two extension flaps may be removably attached to the main cover portion.

Another embodiment may be vehicle windshield glass covering extension flaps comprising: a first extension flap; a second extension flap; where the first extension flap may be configured to attach to a side flap of a windshield glass covering device; where the second extension flap may be configured to attach to a side flap of a windshield glass covering device. The first extension flap may comprise a water-resistant material. The second extension flap may comprise a water-resistant material. The first extension flap may be permanently attached to the windshield glass covering device. The second extension flap may be permanently attached to the windshield glass covering device. The first extension flap may be configured to fold underneath the windshield glass covering device. The second extension flap may be configured to fold underneath the windshield glass covering device.

Another embodiment may be vehicle windshield glass covering extension flaps comprising: a first extension flap and a second extension flap. The first and second extension flaps may be configured to attach to side flaps of a windshield glass covering device. The first extension flap may comprise a water-resistant material. The second extension flap may comprise a water-resistant material. The first extension flap may be removably attached to the windshield glass covering device. The first extension flap may be configured to fold underneath the windshield glass covering device. The second extension flap may be configured to fold underneath the windshield glass covering device. The second extension flap may be removably attached to the windshield glass covering device. The first extension flap water-resistant material may be highly durable. The second extension flap water-resistant material may be highly durable. The first extension flap may further comprise a first extension flap bottom piece. The first extension flap bottom piece may be attached to the first extension flap. The second extension flap may further comprise a second extension flap bottom piece. The second extension flap bottom piece may be attached to the second extension flap.

Another embodiment may be vehicle windshield glass covering extension flaps comprising: a first extension flap; a second extension flap; wherein the first extension flap may be configured to attach to a side flap of a windshield glass covering device; wherein the second extension flap may be configured to attach to a side flap of a windshield glass covering device; wherein the first extension flap may be configured to fold underneath the windshield glass covering device; wherein the second extension flap may be configured to fold underneath the windshield glass covering device. The first extension flap may comprise a water-resistant material. The second extension may flap comprise a water-resistant material. The first extension flap may be removably attached to the windshield glass covering device. The second extension flap may be removably attached to the windshield glass covering device. The first extension flap water-resistant material may be highly durable. The second extension flap water-resistant material may be highly durable. The first extension flap may further comprise a first extension flap bottom piece. The first extension flap bottom piece may be attached to the first extension flap. The second extension flap may further comprise a second extension flap bottom piece. The second extension flap bottom piece may be attached to the second extension flap. The first extension flap bottom piece material may be nonabrasive. The second extension flap bottom piece material may be nonabrasive. The first extension flap bottom piece material may be the same as the window covering glass device. The second extension flap bottom piece material may be the same as the window covering glass devices.

It is an object to provide a vehicle windshield protective device that adequately covers the entire windshield of different sized vehicles.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a prior art windshield cover.

FIG. 2 is an illustration of a bottom view of one embodiment of a windshield cover with extension flaps, wherein extension flaps are extended.

FIG. 3 is an illustration of a bottom view of one embodiment of the windshield cover with extension flaps, wherein the extension flaps are folded inward.

FIG. 4 is an illustration of a top view of one embodiment of the windshield cover with extension flaps, wherein the extension flaps are extended.

FIG. 5 is an illustration of a top view of one embodiment of the windshield cover with extension flaps, wherein the extension flaps are folded inward.

FIG. 6 is an illustration of a top view of one embodiment of the windshield cover that is on a vehicle and shows that the extension flap covers a portion of the windshield that the main cover portion could not.

### DETAILED DESCRIPTION OF THE DRAWINGS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein the term “windshield cover” or “windshield covering” refers to any windshield protective device that is used to cover a vehicles windshield in order to provide a layer of protection to the exterior of the glass windshield.

As used herein the term “extension flap” refers to any flap, strap, portion, and/or section of material that may be affixed removably or permanently to the sides, edges, and/or surfaces of a windshield cover in order to provide more coverage of an underlying vehicle windshield.

As used herein the term “security strap” refers to any flap, strap, section of material that may be affixed removably or permanently to the side of a windshield cover.

As used herein the term “rod” or “support member” refers to straight slender shaped bar or staff, made of any material such as, but not limited to, wood, metal, PVC that may be cylindrical, square, or oval in shape. It preferably has the strength and necessary stiffness needed maintain a products shape and or volume when placed on a vehicle. Support members and rods may preferably substantially prevent the windshield cover from flapping in the wind, or being blown out of place by the wind.

As used herein the term “connection strap” refers to any elongated flap, strap, swatch, or section of material, and may be made from plastic, metal, and the like.

As used herein the term “suction cup” refers to a cup, flat, or bellows-shaped object of silicone, rubber, glass, plastic, and the like, which, by producing a partial vacuum, can be made to adhere to, stick, or draw something to a surface.

The cover portion, security straps, and extension flaps may be comprised of a Polyvinyl Chloride coating, wherein the Polyvinyl Chloride coating allows the cover portion remain flexible in temperatures below 0° C. The cover portion, security straps, and extension flaps may be made from one or more layers of a durable, weather resistant material, such as canvas, fabric, or insulated fabric, which may then be coated with the PVC coating.

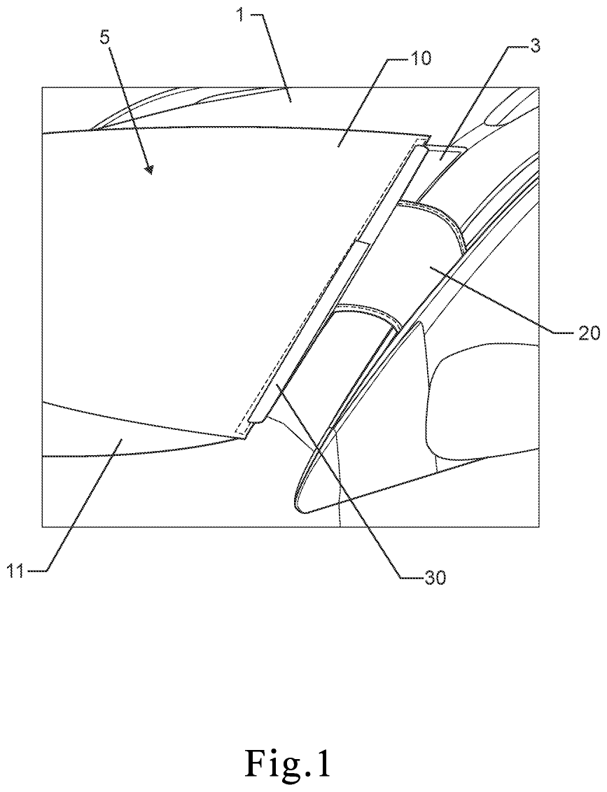

FIG. 1 is an illustration of a prior art windshield cover. As shown in FIG. 1, vehicle 1 may have windshield 3 be covered by prior art windshield cover 5. As shown, although windshield cover 5 comprises a main cover portion 10, wiper cover portion 11, security strap 20, and straps 30, the windshield cover 5 may deficiently cover windshield 3. Although cover 5 may have been sufficient for another smaller vehicle that the owner of vehicle 1 also has, cover 5 is unable to adequately also cover vehicle 1. Thus, what is needed is a cover that can expand or be expanded so that it can fit on multiple vehicles that are different sizes.

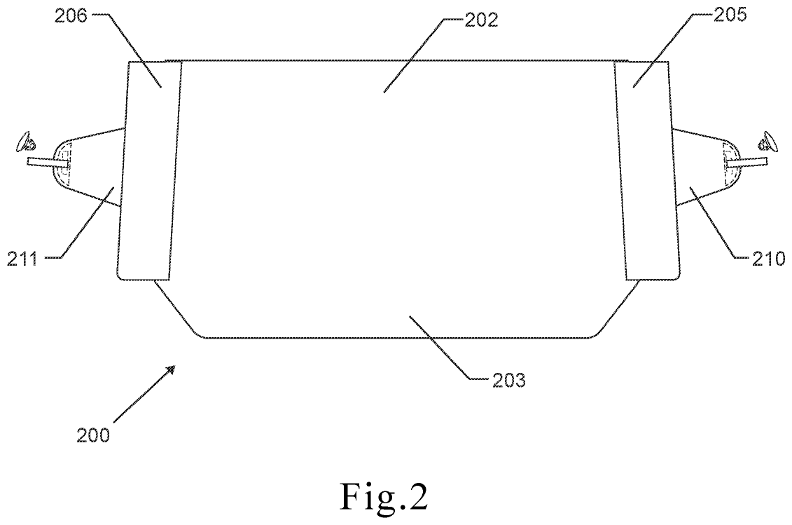

FIG. 2 is an illustration of a bottom view of one embodiment of a windshield cover with extension flaps, wherein extension flaps are extended. As shown in FIG. 2, the bottom face or surface of the windshield cover 200 may comprise main cover portion 202, wiper cover portion 203, extension flaps 205, 206, and security straps 210, 211. Although the extension flaps 205, 206 are shown on the bottom face of windshield cover 200, they may be on the very edges of the main cover portion 202 or on the top surface of windshield cover 200. Additionally, the extension flaps are shown as running the entire length of the main cover portion 202, but they may be shorter, or even longer than cover portion 202. Although wiper cover portion 203 is shown without extension flaps, the extension flaps may extend to expand the wiper cover portion. FIG. 2 shows the extension flaps in an extended or folded outward configuration. As shown in this configuration, the extension flaps 205, 206 provide additional coverage over the windshield of the vehicle. Specifically, the extension flaps 205, 206 provide more coverage over the engage windshield as compared to when the extension flaps 205, 206 are not extended. The windshield cover 200 will be able to lay flat against the windshield with the extension flaps 205, 206 extended.

As shown in FIG. 2, windshield cover 200 may now cover a larger vehicle windshield than is possible without the extension flaps 205, 206 being extended. The security straps 210, 211 may be attached to the windshield cover 200 main cover portion 202 in a manner that is separate from how and where the extension flaps 205, 206 are attached. Alternatively, extension flaps 205, 206 may be attached concurrently or adjacently to the security straps 210, 211. FIG. 2, which is a bottom view, shows that the security straps 210, 211 are on top the extended extension flap 205, 206, respectively. Having the security straps 210, 211 be separately attached, with respect to the extension flaps 205, 206 allows for the independent operation of the extension flaps 205, 206 from the security straps 210, 211. This also allows the extension flaps 205, 206 to be held in place by the security straps 210, 211 when deployed simultaneously.

FIG. 2 shows, as preferred, that the extension flaps 205, 206 may each be a unitary and undivided portion. The extension flaps 205, 206 may be comprised of a two or more dividable portions.

In some embodiments, the extension flaps may be removably attached to the windshield cover. In this manner even more flexibility is given because smaller extension flaps may be swapped out for wider or longer extension flaps.

In other embodiments, such as when the windshield cover does not have security straps, the extension flaps may be weighted so that they are substantially prevented from being blown out of place. The weight may be provided by an extra layer of fabric, insulation, plastic pellets, glass beads, sand, steel beads, pebbles, and the like.

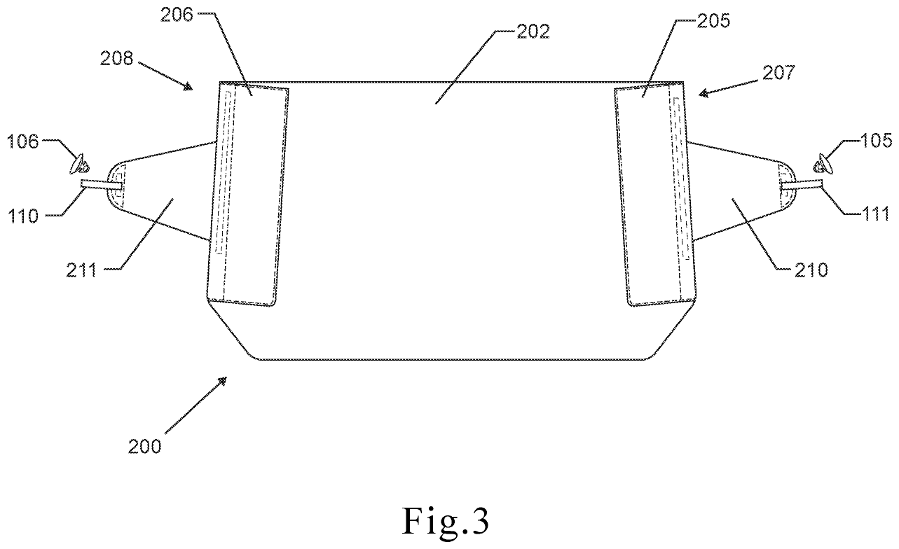

FIG. 3 is an illustration of a bottom view of one embodiment of the windshield cover with extension flaps, wherein the extension flaps are folded inward. As shown in FIG. 3, the windshield cover 200 may comprise a main cover portion 202, security straps 210, 211, extension flaps 205, 206, connection straps 110, 111, and suction cups 105, 106. The extension flaps 205, 206, when folded inward, may lay flat against the bottom surface of the windshield cover 200. The extension flaps 205, 206 may be held in place against the bottom surface of the windshield cover 200 in a folded away position by friction, snaps, hook and eye, clasps, friction locking hinge, tackiness, failable adhesive, and the like. FIG. 3 shows that the extension flaps 205, 206 may be folded at hinges 207, 208, respectively. Preferably, hinges 207, 208 may be a type of living hinge or just thinner portion of extension flaps 205, 206. Hinges 207, 208 may be at or approximately adjacent to where extension flaps 205, 206 connect with the main cover portion 202.

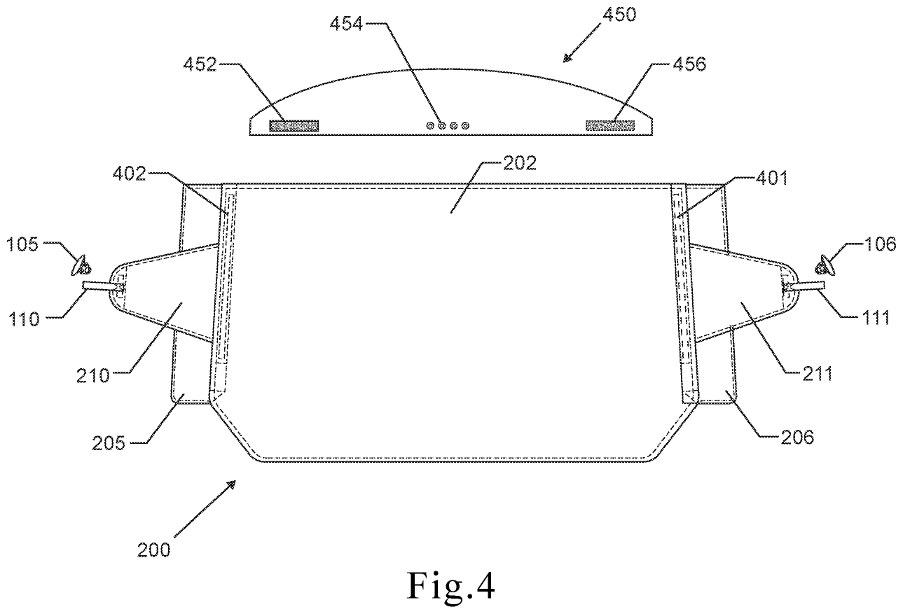

FIG. 4 is an illustration of a top view of one embodiment of the windshield cover with extension flaps, wherein the extension flaps are extended. As shown in FIG. 4, windshield cover 200 may comprise a main cover portion 202, security straps 210, 211, extension flaps 205, 206, support members 401 and 402, connection straps 110, 111, and suction cups 105, 106. As shown, the extension flaps 205, 206 may be connected to the side edges of the main cover portion 202 or adjacent to the side edges, but on the bottom surface of the windshield cover 200. The security straps 210, 211 may preferably be attached to the side edges of the main cover portion 202 and may be in front of the extension flaps 205, 206. In order to serve their purposes and not interfere with the each other, the security straps 210, 211 are typically longer than the extension flaps 205, 206. When in place on the vehicle, the security straps 210, 211 may be used to hold the extension flaps 205, 206 substantially in place.

In one embodiment, the extension flaps 205, 206 may be permanently attached to main cover portion 202. In alternative embodiments, one or more of the extension flaps may be removably attached. Additionally, the extension flaps may be added to the top and bottom edges of the main cover portion 202, not just the right and left sides, which is where extension flaps 205, 206 are shown. FIG. 4 shows that top extension flap 450, which is not yet attached to main cover portion. Extension flap 450 may be connected to the top edge, top surface, or bottom surface of main cover portion 202. The removable connection may be done via a fastener, such as hook and loop 452, snaps or buttons 454, and/or the like. In other embodiments, the removable connection may be done by an adhesive 456 or tackiness, which is failable and re-attachable. FIG. 4 also shows that the extension flap 450 may be shorter than the side or edge to which it may be attached.

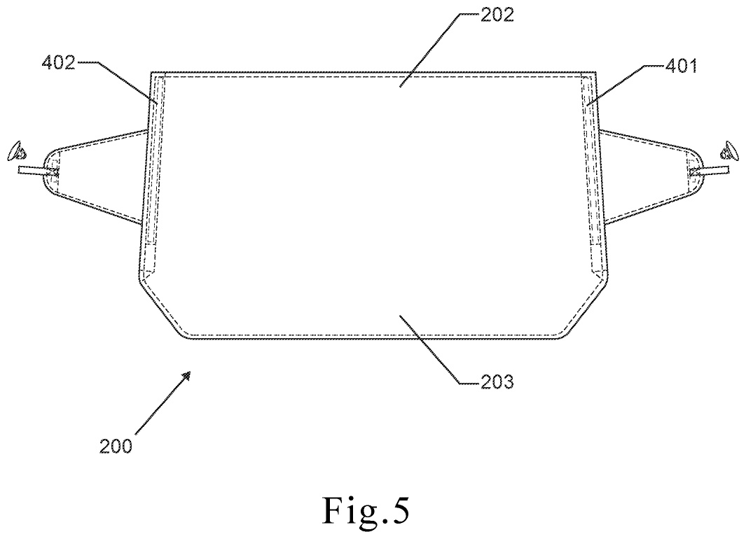

FIG. 5 is an illustration of a top view of one embodiment of the windshield cover with extension flaps, wherein the extension flaps are folded inward. As shown in FIG. 5, the windshield cover 200 may comprise wiper cover portion 203, main cover portion 202, and support members 401, 402.

As shown in FIG. 5, the windshield cover 200 extension flaps 205, 206 may remain folded and stored beneath the main cover portion 202 if not required, which is when the windshield cover 200 appropriately and/or completely covers the vehicle windshield. In the configuration shown in FIG. 5 the windshield cover 200 provides a covering for a smaller vehicle windshield, such that the extension flaps 205, 206 are not needed.

The windshield cover 200, including the main cover portion 202, security straps, and extension flaps 205, 206 may be made from, canvas, plastic, or cloth material that may preferably be coated with nylon or poly-10 vinyl chloride, such that the windshield cover 200 may remain flexible in temperatures below 0° C., may be extremely durable, and water/weather resistant.

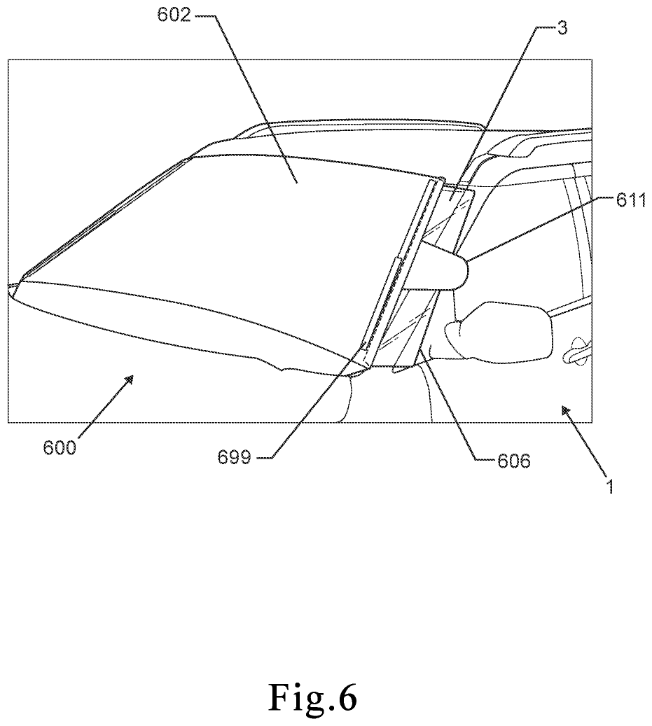

FIG. 6 is an illustration of a top view of one embodiment of the windshield cover that is on a vehicle and shows that the extension flap covers a portion of the windshield that the main cover portion could not. As shown in FIG. 6, windshield cover 600, which is shown on the windshield 3 of vehicle 1, may comprise main cover portion 602, side straps 699, security strap 611, and extension flap 606. Extension flap 606 is shown in an extended position, such that extension flap 606 covers a portion of the vehicle 1. Although the extension flap 606 is shown as being transparent in FIG. 6, this is primarily for the purpose of illustrating what portion of the windshield 3 is covered by extension flap 606. When the windshield cover 600 has both security straps 611 and side straps 699, either or both may be used to secure the cover on the vehicle.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the devices, systems, and methods of the present disclosure has been presented for the purposes of illustration and description. While multiple embodiments are disclosed, still other embodiments of the present disclosure will become apparent to those skilled in the art from the above detailed description, which shows and describes illustrative embodiments of the present disclosure. As will be realized, the devices, systems, and methods of the present disclosure is capable of modifications in various obvious aspects, all without departing from the spirit and scope of the present disclosure. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of the present disclosure is not limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A vehicle windshield cover, comprising:
a main cover portion; and
one or more extension flaps;
wherein said one or more extension flaps are attached to said main cover portion;
wherein said one or more extension flaps have an extended position and a folded position; and
wherein when said one or more extension flaps are in said extended position, said vehicle windshield cover is configured to cover a windshield that is larger than that which can be covered by said vehicle windshield cover when said one or more extension flaps are in said folded position.

2. The vehicle windshield cover of claim 1, further comprising:
one or more security straps.

3. The vehicle windshield cover of claim 1, further comprising:
one or more side straps.

4. The vehicle windshield cover of claim 1, wherein said one or more extension flaps are two extension flaps.

5. The vehicle windshield cover of claim 4, wherein said two extension flaps are attached to two opposing sides of said main cover portion.

6. The vehicle windshield cover of claim 5, wherein said two extension flaps are permanently attached to a bottom surface of said main cover portion, such that when said two extension flaps are in said folded position they are substantially held flat against said bottom surface of said main cover portion when said vehicle windshield cover is engaged with a vehicle windshield.

7. The vehicle windshield cover of claim 5, wherein said two extension flaps are removably attached to said main cover portion.

8. The vehicle windshield cover of claim 5, wherein said two extension flaps are approximately the same length as said two opposing sides of said main cover portion.

9. The vehicle windshield cover of claim 1, wherein said one or more extension flaps are weighted.

10. The vehicle windshield cover of claim 1, wherein said one or more extension flaps have a Polyvinyl Chloride coating, such that said one or more extension flaps remain flexible in temperatures below 0° C.

11. An extension flap for a vehicle windshield cover, comprising:
a first extension flap;
wherein said first extension flap is configured to attach to a main cover portion of a vehicle windshield cover;
wherein said first extension flap has an extended position and a folded position;
wherein when said first extension flap is in said extended position, said vehicle windshield cover is configured to cover a windshield that is larger than that which can be covered by said vehicle windshield cover when said first extension flap is in said folded position.

12. The extension flap of claim 11, further comprising:
a second extension flap, such that there are two extension flaps.

13. The extension flap of claim 12, wherein said two extension flaps are attached to two opposing sides of said main cover portion.

14. The extension flap of claim 13, wherein said two extension flaps are permanently attached to a bottom surface of said main cover portion, such that when said two extension flaps are in said folded position they are substantially held flat against said bottom surface of said main cover portion when said vehicle windshield cover is engaged with a vehicle windshield.

15. The extension flap of claim 13, wherein said two extension flaps are removably attached to said main cover portion.

16. The extension flap of claim 12, wherein said two extension flaps are approximately the same length as said two opposing sides of said main cover portion.

17. The extension flap of claim 11, wherein said first extension flap has a Polyvinyl Chloride coating, such that said first extension flap remains flexible in temperatures below 0° C.

18. A vehicle windshield cover, comprising:
a main cover portion;
one or more security straps; and
two extension flaps;
wherein said two extension flaps are attached to two opposing sides of said main cover portion;
wherein said two extension flaps have an extended position and a folded position;
wherein when said two extension flaps are in said extended position, said vehicle windshield cover is configured to cover a windshield that is larger than that which can be covered by said vehicle windshield cover when said two extension flaps are in said folded position.

19. The vehicle windshield cover of claim 18, wherein said two extension flaps are permanently attached to a bottom surface of said main cover portion, such that when said two extension flaps are in said folded position they are substantially held flat against said bottom surface of said main cover portion when said vehicle windshield cover is engaged with a vehicle windshield.

20. The vehicle windshield cover of claim 18, wherein said two extension flaps are removably attached to said main cover portion.
